(19) United States
(12) Patent Application Publication
(10) Pub. No.: US 2015/0378022 A1
(43) Pub. Date: Dec. 31, 2015

(54) METHOD AND SYSTEM FOR PROVIDING A MOBILE DEVICE WITH INFORMATION ON THE POSITION THEREOF RELATIVE TO A TARGET, ROBOT INTEGRATING SUCH A SYSTEM AND TABLET

(71) Applicant: ARCHOS, Igny (FR)

(72) Inventor: Raul MALLART, Paris (FR)

(21) Appl. No.: 14/761,039

(22) PCT Filed: Jan. 14, 2014
(86) PCT No.: PCT/EP2014/050530

§ 371 Date: Jul. 15, 2015

(30) Foreign Application Priority Data
Jan. 18, 2013 (FR) 1350460

(51) Int. Cl. G01S 17/46; G01S 7/497; G05D 1/02; G01S 17/89

(52) U.S. Cl. CPC G01S 17/46; G01S 17/89; G01S 7/4972; G05D 1/024; G05D 1/0248; Y10S 901/01

(57) ABSTRACT

A method is disclosed for providing a mobile device with information on the position thereof relative to a target, including: transmitting, from a laser source connected to the mobile device, a laser beam substantially diverging in an emission plane oriented such that the emitted beam illuminates the target at least partially, capturing an image of the partially illuminated scene from an imaging apparatus that is connected to the mobile device in order to capture an image, and processing the image thus captured in order to generate information on the position of the mobile device relative to the target.

### TECHNICAL FIELD

The present invention relates to a method and system for providing a mobile device with information on the position thereof relative to a target.

It also relates to a robot integrating such a system. It also relates to a tablet communicating with such a robot and implementing such a method.

The field of the invention is non-limitatively that of domestic robots and more particularly that of guiding domestic robots.

### STATE OF THE PRIOR ART

Systems are known for detecting the distance between a robot and an obstacle, for example the one used in the Sharp system (cf.:http://www.acroname.com/robotics/info/articles/sharp/sharp.html#e2).

This system comprises a light source and a linear sensor. When light is reflected by the obstacle, this reflection is detected by the sensor. The position of the reflection on the sensor defines an angle which allows the distance from the robot to the obstacle to be deduced.

Improvements on this system exist and use a laser as a light source. The sensor is linear. The laser illumination allows a light point to be projected onto the obstacle. By forming an image of the visual field captured by the linear sensor, it is possible to determine the distance from this light point by trigonometry.

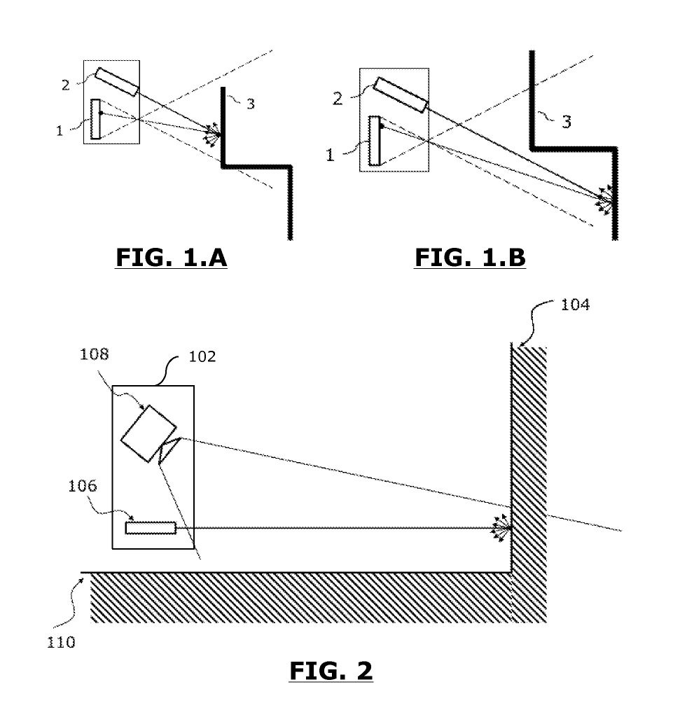

With reference to FIG. 1, it is noted that the position of the image of the laser point on the obstacle—captured by the linear image sensor—depends on the distance from the obstacle and allows this distance to be determined.

This system only allows the distance from one point to be given. In order to obtain a distance map, it is therefore necessary to scan the system.

This scanning is typically circular, as for example in the NEATO robot which is a domestic vacuum cleaner. In the NEATO system, the laser and the image sensor are placed side by side on a rotary support equipped with sliding contact. This is with the aim of ensuring the electricity supply and the retrieval of data from the system in rotation.

Assuming an angular resolution of 1° and a capture speed of 360 images per second, this system makes it possible to capture a distance map over 360° in 1 second.

The cost price of such a system is of the order of $20.

An objective of the invention is to propose a method, system, robot and tablet which are more cost-effective to manufacture than the current robot guidance systems. A price of the order of $3 is envisaged.

Another objective of the invention is therefore to propose a method, system, robot and tablet which increase the rate of measurement.

A further purpose of the invention is to propose a method, system, robot and tablet which dispense with the moving parts. Such an objective increases the reliability of the system. Such an objective reduces its cost. Such an objective reduces its complexity.

### DISCLOSURE OF THE INVENTION

At least one of these objectives is achieved with a method for providing a mobile device with information on the position thereof relative to a target, comprising:

emitting, from a laser source linked to said mobile device, a laser beam diverging substantially in a plane of emission oriented so that said emitted beam at least partially illuminates said target,

capturing an image, from imaging equipment linked to said mobile device, of said partially illuminated scene, in order to capture an image,

processing the image thus captured so as to produce information on the position of said mobile device relative to said target.

The imaging equipment can for example be situated substantially above the plane of emission.

In addition, the method according to the invention can implement a pixelated capture and the processing of the captured image can comprise a two-dimensional detection of the pixels corresponding to areas of the illuminated scene.

In addition, the position information can comprise a distance map.

In addition, the distance map can have an angular width substantially equal to the divergence angle of the emitted laser beam.

In addition, the processing of the captured image can comprise a detection of the pixels corresponding to the areas of the illuminated scene, so that the distance map is obtained in a single shot.

In addition, the processing of the captured image can comprise for each pixel corresponding to the areas of the illuminated scene, a determination of the horizontal position so as to provide an item of information on the angular position of the mobile device and a detection of the vertical position of the pixel so as to provide an item of distance information of the mobile device.

In addition, the method according to the invention can also comprise a capture prior to the emission, during which an image capture is carried out while the laser beam is not emitted.

In addition, the capture can be carried out along an optical axis of the imaging equipment forming an angle (α) with the plane of emission of the laser beam, characterized in that the angle (α) is variable.

In addition, the method according to the invention can also comprise a step of calibration, called angular calibration, carried out by a supplementary processing of positions in order to determine an item of position information, called reference position information, resulting from a capture of an image of an element, called a reference element.

In addition, the method according to the invention can also comprise a step of angular calibration, and the angular calibration can be carried out several times.

In addition, the method according to the invention can also comprise a step of spatial calibration, and the spatial calibration can be carried out several times.

According to another aspect of the invention, a system is proposed for providing a mobile device with information on the position thereof relative to a target, implementing the method according to any one of the preceding claims, comprising:

a laser source linked to said mobile device, provided in order to emit a laser beam diverging substantially in a plane of emission oriented so that said emitted beam at least partially illuminates said target,

imaging equipment linked to said mobile device, provided in order to capture an image of said target,

means for processing the image thus captured so as to produce information on the position of said mobile device relative to said target.

The imaging equipment can for example be situated substantially above the plane of emission.

In addition, the imaging equipment can comprise a CCD camera.

In addition, the imaging equipment can be configured to carry out an image capture when the laser beam is not emitted. Thus, the image processing means can be configured to detect the positions on the detector when the laser beam is emitted.

The imaging equipment can be configured so that the laser beam on a flat surface forms an angle (α) with the optical axis of the imaging equipment, characterized in that the angle (α) varies.

In addition, the system according to the invention can also comprise calibration means, called angular calibration means, comprising means for supplementary processing of the positions on the detector configured to utilize a reference position resulting from an image capture of a reference emission module.

In addition, the system according to the invention can also comprise repetition means configured to implement the angular calibration means several times. In addition, the system according to the invention can also comprise repetition means configured to implement the spatial calibration means several times.

According to another aspect of the invention, a mobile robot is proposed, integrating a position measurement system according to the invention.

The robot according to the invention can be arranged in order to receive and communicate with a digital tablet comprising image processing means arranged in order to determine a distance between the laser and a point of impact of the laser beam on the obstacle, as a function of a position of the reflected beam on the detector.

According to another aspect of the invention, there is proposed a digital tablet comprising means for detecting a light beam and communication means, characterized in that the communication means are configured to communicate with a robot and in that it is configured to guide the robot according to a method according to the invention.

Description of the figures and embodiments. Other advantages and characteristics of the invention will become apparent on reading the detailed description of implementations and embodiments which are in no way limitative, and the attached diagrams, in which:

FIGS. 1A and 1B show the operating principle of a system according to the prior art,

FIG. 2 shows the operating principle of a method according to the invention,

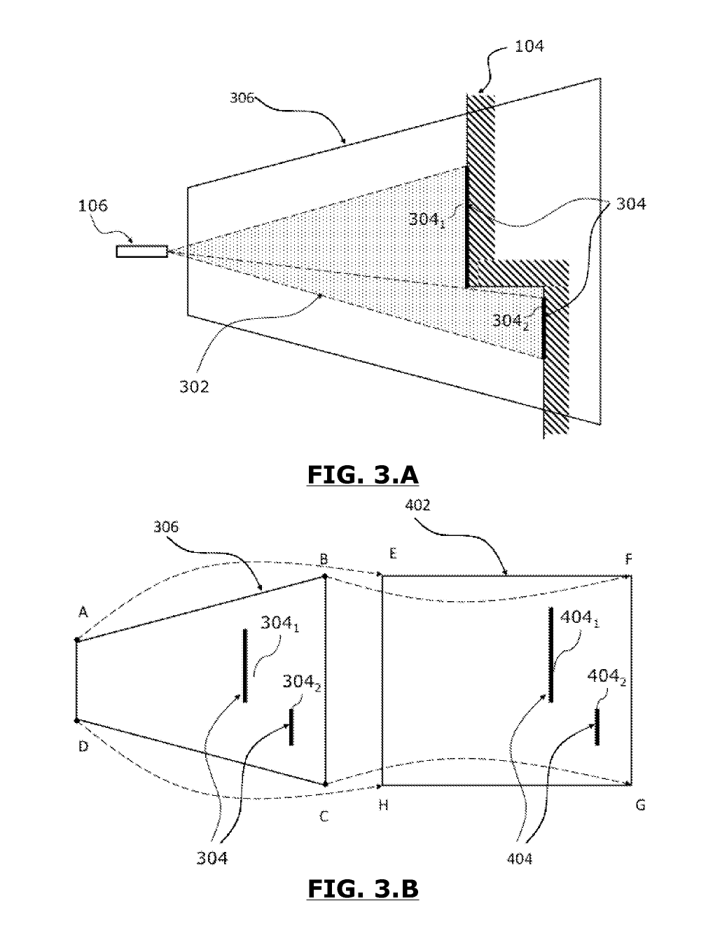

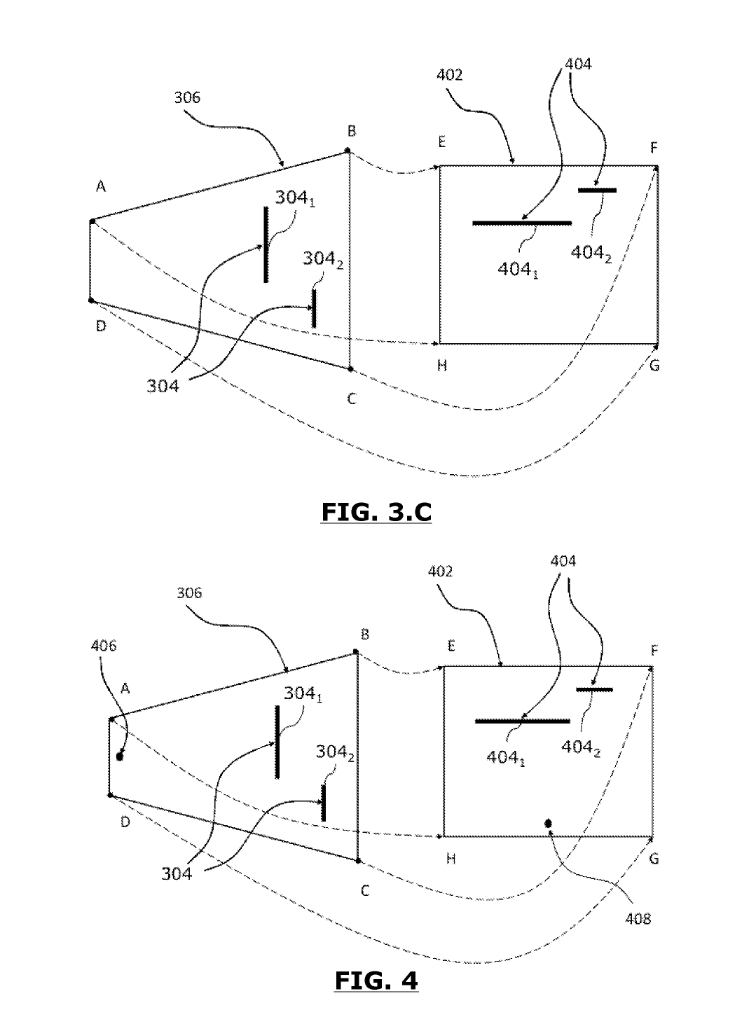

FIGS. 3A, 3B and 3C show a principle for obtaining a distance map in a single shot,

FIG. 4 shows a principle of calibration of a method according to the invention, and

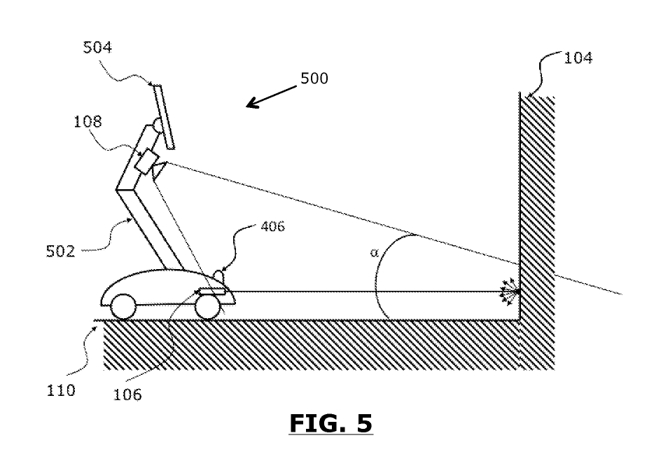

FIG. 5 shows a system 500 according to the invention according to a preferred embodiment.

The operating principle of a system according to the prior art will now be described with reference to FIGS. 1.A and 1.B. These two figures comprise a single laser emitter 1 and linear image sensor 2 arranged in a horizontal plane. The two FIGS. 1.A and 1.B differ by the position of an obstacle 3 represented by a wall perpendicular to the horizontal plane.

FIGS. 1.A and 1.B show the difference in the position of a pixel on the linear image sensor 2 corresponding to an area of the obstacle 3 illuminated by the laser emitter 1.

This system only allows the distance of one point to be given. In order to obtain a distance map, it is therefore necessary to carry out a scan of the target by the system. This scanning is typically circular, as for example in the NEATO robot.

With reference to FIG. 2, the operating principle of a method according to a preferred embodiment of the invention will now be described. The method provides a mobile device 102 with information on the position thereof relative to a target 104.

A linear laser 106 and a CCD sensor 108 are also represented in FIG. 2.

During a step called an emission step, from the linear laser 106 linked to the mobile device 102, a laser beam at least partially illuminates the target 104. The beam diverges substantially in an emission plane oriented so that the emitted beam at least partially illuminates the target 104. The emission plane is perpendicular to the plane of FIG. 2 and parallel to the floor represented by the element 110.

During a step called the image capture step, the CCD sensor 108 linked to the mobile device 102 captures an image of said partially illuminated scene. The capture is pixelated.

During an image processing step, the image thus captured is processed so as to produce information on the position of the mobile device relative to said target. Processing the captured image comprises a two-dimensional detection of the pixels corresponding to the areas of the illuminated scene. The position information comprises a distance map. The distance map has an angular width substantially equal to the divergence angle of the emitted laser beam.

With reference to FIGS. 3A, 3B and 3C, an explanation will now be given of how the detection of the pixels corresponding to the areas of the illuminated scene makes it possible to obtain a distance map in a single shot. FIG. 3.A is a top view of the elements shown in FIG. 2. Thus in FIG. 3A a linear laser 106 is represented on the left of the figure illuminating a wall 104 situated on the right of the figure.

The illumination is carried out by means of a pencil beam 302. The frame 306 indicates the field of view of the CCD sensor 108 (not shown) intercepted by the plane of the light beam emitted by the linear laser 106. The lines 304₁ and 304₂ in the field of view 306 represent the light lines due to the illumination of the wall 104 by the linear laser 106.

The wall 304 has two parts. A first part, called the upper part, is closer to the linear laser 106 than to the part called the lower part. Furthermore, the upper part corresponds to a part on the left and in the centre of the light beam, while the lower part corresponds to a part on the right of the light beam.

FIG. 3B shows a geometrical connection existing between the field of view 306 of the CCD sensor 108 intercepted by the plane of the light beam and the image 402 captured by the CCD sensor 108.

The field of view 306 of the camera is delimited by the apexes A, B, C, and D of a trapezium. The lines 304₁ and 304₂ as defined previously are also represented inside the field of view 306 of the camera.

The image 402 captured by the CCD sensor is represented by a square of apexes E, F, G and H.

The arrows associating respectively the apexes A and E, B and F, C and G, D and H show the correspondence existing between an illuminated area of the field of view 306 and a pixel of the image 402 captured by the CCD sensor 108.

Pixels 404 corresponding to the illuminated areas 304 are drawn in the captured image 402. The lines 304₁ and 304₂ are thus associated with rows of pixels 404₁ and 404₂. It should be noted that the further an obstacle is from the CCD sensor 108, the further it is to the right in the image 402 captured by the CCD sensor 108. Similarly, the further an obstacle is to the left of the CCD sensor 108, the higher it is in the captured image 402.

Thus, a determination of the horizontal position provides an item of information on the distance from the CCD sensor to the obstacle. A determination of the vertical position on the captured image 402 provides an item of information on the angular position of the mobile device relative to the obstacle.

FIG. 3C shows another possible association between the field of view 306 of the CCD sensor 108 intercepted by the plane of the light beam and the image 402 captured by the CCD sensor 108.

FIG. 3C is identical to FIG. 3B with the exception of the associations made between the apexes A, B, C and D of a trapezium delimiting the field of view 306 of the camera and the apexes E, F, G and H representing the captured image 402.

The lines 304₁ and 302₂ as defined previously are also represented inside the field of view 306 of the camera.

The arrows associating respectively the apexes A and H, B and E, C and F, D and G show the new correspondence existing between an illuminated area of the field of view 306 and a pixel of the image 402 captured by the CCD sensor 108.

This correspondence allows a determination of the horizontal position of a pixel so as to provide an item of information on the angular position of the mobile device. It also allows a detection of the vertical position of the pixel so as to provide an item of information on the distance from the CCD sensor to the obstacle.

FIG. 4 shows a step of calibration, called angular calibration, carried out by a supplementary processing of positions on the imaging equipment in order to determine an item of position information, called reference position information, resulting from a capture of an image of an element, called a reference element. FIG. 4 contains the same elements as FIG. 3C. Also represented in FIG. 4 is a light-emitting diode (LED) 406 placed at a known distance from the CCD sensor 108 and visible in the field of view 306 of the CCD sensor 108. This light-emitting diode corresponds to pixels 408 of the sensor 108 in the image captured by the CCD sensor 108. As has been disclosed, the vertical position of these pixels 408 provides an item of information on the distance from the CCD sensor to the light-emitting diode 406.

The vertical position of these pixels 408 is associated with the known distance from the diode 406 to the CCD sensor 108. The light-emitting diode 406 is thus a reference element an image capture of which allows a calibration of the method according to the invention.

FIG. 5 shows a system 500 for providing a robot 502 with information on the position thereof relative to a target 104, implementing the method which has just been described.

The system 500 comprises:

linear laser 106 linked to the robot 502. The linear laser 106 emits a laser beam that diverges substantially in an emission plane oriented so that said emitted beam at least partially illuminates the target 104,

a CCD sensor 108 linked to the robot 502, provided in order to capture an image of the target 104,

a tablet 504 for processing the image thus captured so as to produce information on the position of the robot 502 relative to the target 104.

The CCD sensor 108 is configured to carry out an image capture when the laser beam is not emitted.

The angle formed between the optical axis of the CCD sensor 108 and the plane of the beam emitted by the linear laser 106 is marked α. The angle α can vary when the robot 502 moves. In fact, the CCD sensor 108 is fixed on an arm of the robot articulated in rotation relative to the linear laser 106.

The robot 502 receives and communicates with the digital tablet 504.

The digital tablet with the robot 502 and is configured to guide the robot 502 according to a method according to the invention.

Of course, the invention is not limited to the examples which have just been described and numerous adjustments can be made to these examples without exceeding the scope of the invention.

1. A method for providing a mobile device with information on the position thereof relative to a target, comprising:
emitting, from a laser source linked to said mobile device, a laser beam diverging substantially in a plane of emission oriented so that said emitted beam at least partially illuminates said target;
capturing an image, from imaging equipment linked to said mobile device , of said partially illuminated scene, in order to capture an image; and
processing the image thus captured so as to produce information on the position of said mobile device relative to said target.

2. The method according to claim 1, implementing a pixelated capture, characterized in that the processing of the captured image comprises a two-dimensional detection of the pixels corresponding to areas of the illuminated scene.

3. The method according to claim 2, characterized in that the position information comprises a distance map.

4. The method according to claim 3, characterized in that the distance map has an angular width substantially equal to the divergence angle of the emitted laser beam.

5. The method according to claim 3, characterized in that the processing of the captured image comprises a detection of the pixels corresponding to the areas of the illuminated scene, so that the distance map is obtained in a single shot.

6. The method according to claim 5, characterized in that the processing of the captured image comprises for each pixel corresponding to an area of the illuminated scene, a determination of the horizontal position so as to provide an item of information on the angular position of the mobile device and a detection of the vertical position of said pixel so as to provide an item of distance information of said mobile device.

7. The method according claim 1, also comprising a step of capture prior to the emission, during which an image capture is carried out while the laser beam is not emitted.

8. The method according to claim 1, in which the capture is carried out on an optical axis of the imaging equipment forming an angle (α) with the plane of emission of the laser beam, characterized in that the angle (α) is variable.

9. The method according to claim 1, characterized in that it also comprises a step of calibration, called angular calibration, carried out by a supplementary processing of positions on the imaging equipment in order to determine an item of position information, called reference position information, resulting from a capture of an image of an element, called a reference element.

10. A system for providing a mobile device with information on the position thereof relative to a target, implementing the method according to claim 1, comprising:
a laser source linked to said mobile device, provided in order to emit a laser beam diverging substantially in a plane of emission oriented so that said emitted beam at least partially illuminates said target;
imaging equipment linked to said mobile device, provided in order to capture an image of said target; and
means for processing the image thus captured so as to produce information on the position of said mobile device relative to said target.

11. The system according to claim 10, characterized in that the imaging equipment comprises a CCD camera.

12. The system according to claim 11, characterized in that the imaging equipment is configured to carry out an image capture when the laser beam is not emitted.

13. The system according to claim 10, in which the imaging equipment is configured so that the laser beam on a flat surface forms an angle (α) with the optical axis of the imaging equipment, characterized in that the angle (α) varies.

14. The system according to claim 10, also comprising calibration means, called angular calibration means, comprising means for processing positions on the detector configured to utilize a reference position resulting from a reference image capture of an emission module.

15. A mobile robot integrating a position measurement system according to claim 10.

16. The robot according to claim 15, characterized in that it is arranged in order to receive and communicate with a digital tablet comprising image processing means arranged in order to determine a distance between the laser and a point of impact of the laser beam on the obstacle, as a function of a position on the detector.

17. A digital tablet comprising: means for detecting a light beam and communication means; the communication means being configured to communicate with a robot and in that it is configured to guide the robot by implementing the method according to claim 1.
